(19) United States
(12) Patent Application Publication
(10) Pub. No.: US 2020/0078709 A1
(43) Pub. Date: Mar. 12, 2020

(54) FLUID FILTER ASSEMBLY WITH AN IMPROVED VALVE ASSEMBLY

(71) Applicant: Federal-Mogul Motorparts, LLC, Southfield, MI (US)

(72) Inventors: Gary Joseph Osterfeld, Coldwater, OH (US); Daniel Break, Coldwater, OH (US); Vincent Higgins, Celina, OH (US); Francisco Contreras, Chicago, IL (US); Jorge A. Rodriguez, Jardines de Tultitlan (MX)

(21) Appl. No.: 16/123,144

(22) Filed: Sep. 6, 2018

(51) Int. Cl. B01D 27/10; F01M 11/03; B01D 35/30

(52) U.S. Cl. CPC B01D 27/103; B01D 27/106; F01M 2001/1092; B01D 35/30; F01M 11/03

(57) ABSTRACT

The fluid filter assembly includes a container and a filter media that is disposed in the container and partially divides it into an unfiltered space and a filtered space. A bypass valve assembly is disposed at one axial end of the filter media and includes an end cap and a valve housing, which has a through opening. The end cap is in engagement with an end face of the filter media. The bypass valve assembly further includes a valve plug which has a head portion and a tail portion. The valve plug is biased into a closed position by a compression spring and is moveable from the closed position to an open position to allow the fluid to flow directly from the unfiltered space to the filtered space. The valve housing and the end cap are made as a monolithic piece.

### BACKGROUND OF THE INVENTION

### 1. Field of the Invention

The present invention is related generally to a fluid filter assembly which has a relief valve assembly.

### 2. Related Art

Many oil filters include a filtration media which is disposed in a housing and which separates the volume inside the housing into an unfiltered space and a filtered space. An anti-drainback valve is at least partially disposed in the upstream space and is configured to open to allow oil to flow from the unfiltered space to a crankcase of an engine. A bypass valve is also partially disposed in the filtered space and normally closed but is configured to selectively open to allow some oil to bypass the filtration media. Specifically, the bypass valve includes a valve plug and one or more springs that are configured to bias the valve plug into a closed condition and to only allow the valve plug to open, thereby allowing some fluid to flow directly from the unfiltered space to the filtered space, in response to oil pressure in the unfiltered space exceeding a predetermined threshold pressure.

### SUMMARY OF THE INVENTION AND ADVANTAGES

One aspect of the present invention is related to a fluid filter assembly for filtering a fluid. The fluid filter assembly includes a container that surrounds an enclosed volume. A filter media is disposed in the enclosed volume and partially divides it into an unfiltered space and a filtered space. The filter media encircles and extends along a central axis. A bypass valve assembly is disposed at one axial end of the filter media. The bypass valve assembly includes an end cap and a valve housing, which has a through opening. The end cap is in engagement with an end face of the filter media to force the fluid to flow through the filter media in a radial direction. The bypass valve assembly further includes a valve plug which has a head portion and a tail portion. The valve plug is biased into a closed position by a compression spring and is moveable against a spring force from the compression spring from the closed position to an open position to allow the fluid to flow directly from the unfiltered space to the filtered space. The head portion is disposed in the filtered space, and the tail portion extends through the through opening into the unfiltered space. The valve housing and the end cap are made as a monolithic piece.

In other known fluid filter assemblies, the end cap and the valve housing are made as separate pieces from one another and are subsequently joined together. Making the valve housing and end cap as a monolithic piece reduces part waste since material does not have to be removed from a central area of the end cap, as is common. Making the valve housing and end cap as a monolithic piece also reduces the total number of parts in the oil filter assembly, thereby reducing manufacturing time and costs. Also, by making the valve housing and end cap monolithic, this eliminates the metal to metal contact between these components which is common in the industry.

According to another aspect of the present invention, the valve housing has a cylindrical wall, and the tail portion of the valve plug is disposed in an area of the cylindrical wall in both the closed position and in the open position.

According to yet another aspect of the present invention, the tail portion of the valve plug is in a clearance fit relationship with the cylindrical wall of the valve housing.

According to still another aspect of the present invention, the tail portion includes at least two fingers, and each of the fingers presents a notch for receiving one end of the compression spring.

According to yet a further aspect of the present invention, the valve housing defines a spring seat which supports an opposite end of the compression spring from the fingers.

According to still a further aspect of the present invention, the fingers have radially outer-most portions which remain within an area surrounded by the cylindrical wall as the valve plug moves from the open position to the closed position.

According to another aspect of the present invention, the valve housing has a top wall which extends radially inwardly from the end cap.

According to yet another aspect of the present invention, a retainer spring extends from the top wall of the valve housing to an inner surface of the container.

Another aspect of the present invention is related to a method of making an oil filter assembly. The method includes with the step of inserting a compression spring into the valve housing. The method includes with the step of inserting a tail portion of a valve plug into a through opening in the valve housing and engaging the tail portion with the compression spring to bias the valve plug into a closed position wherein a head portion of the valve plug covers the through opening. The method includes the step of preparing a filter media which encircles a central axis. The method includes with the step of fixedly attaching an end cap and a valve housing, which are constructed a single monolithic piece, with an axial end of the filter media. The method includes with the step of inserting the filter media into an enclosed space of a container.

One advantage to the method according to this aspect of the present invention is that the step of locating a valve with a valve housing with an end cap and then fixedly attaching these components together is eliminated. Thus, oil filter assembly can be assembled more quickly and at a lower cost than other known oil filter assemblies.

According to another aspect of the present invention, the valve housing has a cylindrical wall, and the tail portion of the valve plug is in a clearance fit relationship with the cylindrical wall such that the cylindrical wall guides movement of the valve plug between the closed position and an open position.

According to yet another aspect of the present invention, the tail portion of the valve plug includes a two or more fingers, and the step of inserting the tail portion into the through opening includes flexing the fingers.

According to still another aspect of the present invention, the end cap and valve housing are made of metal, and the valve plug is made of plastic.

According to a further aspect of the present invention, the valve housing has a top wall.

According to yet a further aspect of the present invention, the method further includes the step of inserting a retainer spring into the unfiltered space and such that the retainer spring contacts the top wall of the valve housing and an inner surface of the container.

### BRIEF DESCRIPTION OF THE DRAWINGS

These and other features and advantages of the invention will become more readily appreciated when considered in connection with the following description of the presently preferred embodiments, appended claims and accompanying drawings, in which:

FIG. 1 is a perspective and sectional view of an exemplary embodiment oil filter assembly that is constructed according to one aspect of the present invention;

FIG. 2 is a perspective and sectional view of a bypass valve assembly of the oil filter assembly of FIG. 1 and showing a valve plug of the bypass valve assembly in a closed position;

FIG. 3 is a perspective and sectional view of the bypass valve assembly of FIG. 2 but showing the valve plug in an open position; and

FIG. 4 is an enlarged view of a portion of FIG. 1 and centered around the bypass valve assembly.

### DESCRIPTION OF THE ENABLING EMBODIMENT

Referring to the Figures, wherein like numerals indicate corresponding parts throughout the several views, one aspect of the present invention is related to an improved fluid filter assembly 20. In the exemplary embodiment, the fluid filter assembly 20 is a spin-on oil filter assembly 20 for filtering contaminants out of the oil of an internal combustion engine, such as in an automobile. While the following discussion is related to the use of the fluid filter assembly 20 as an oil filter, it should be appreciated that the fluid filter assembly 20 could be configured for use with any suitable type of fluid (e.g., water, gasoline, diesel fuel, etc.) and in any suitable application.

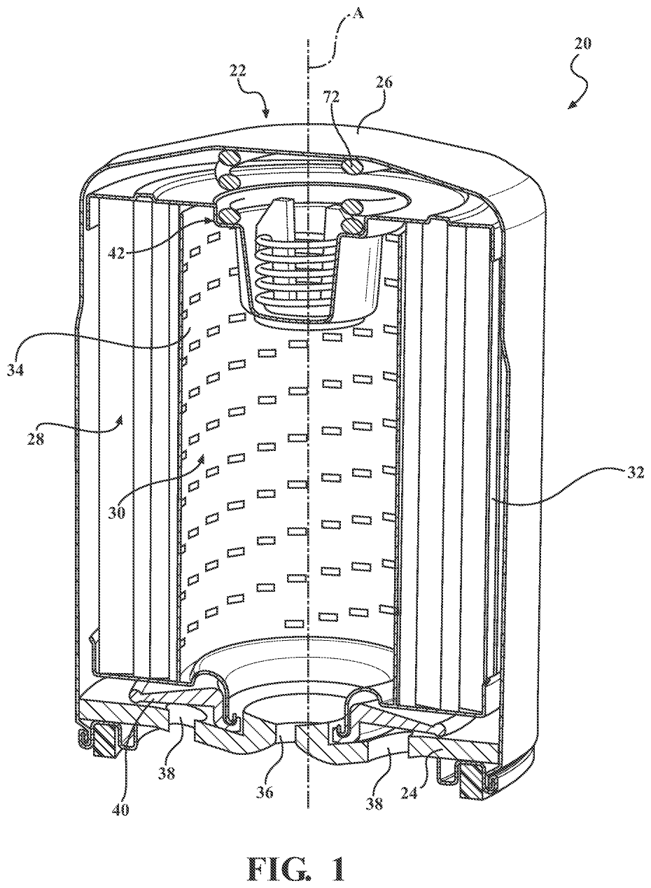

With reference to FIG. 1, the oil filter assembly 20 includes a container 22 in the form of a canister 22 (also known as a shell or a body) and a tapping plate 24 which are fixedly attached with one another via bottom ring. The canister 20 and tapping plate 24 together surround an enclosed volume. The canister 22 extends from the tapping plate 24 along a central axis A to a closed end 26. A filter media 28 is disposed in the enclosed space and encircles the central axis A. The filter media 28 partially separates the enclosed volume into a filtered space 30 and an unfiltered space 32. In the exemplary embodiment, the filter media 28 is corrugated with a plurality of inner peaks and a plurality of outer peaks. An center tube 34 is disposed inside of the filter media 28 and is in engagement with the inner peaks to reinforce the filter media 28. The center tube 34 includes a plurality of spaced apart orifices for allowing fluid to pass from the filter media 28 into the filtered space 30.

The canister 22, the tapping plate 24, the filer media 28, and center tube 34 may be made of any suitable materials. For example, the canister 22, tapping plate 24, and center tube 34 can be made of metal, and the filter media 28 can be made of a range of different materials that are capable of filtering contaminants out of engine oil.

The tapping plate 24 includes a single fluid outlet orifice 36 and a plurality of fluid inlet orifices 36. The fluid outlet orifice 36 is located on the central axis A and is configured to convey oil from the filtered space 30 back to the engine. The fluid inlet orifices 38 are spaced radially outwardly of the fluid outlet orifice 36 and are spaced circumferentially from one another around the central axis A. The fluid inlet orifices 38 communicate with the unfiltered space 32 in the canister 22 for conveying oil from the engine to the unfiltered space 32 during operation of the engine.

The oil filter assembly 20 further includes an anti-drainback valve 40 in the form of a resilient flap which opens to allow oil to flow into the unfiltered space 30 when the engine is running and closes to prevent oil from escaping out of the unfiltered space 30 when the engine is off. Specifically, the anti-drainback valve 40 opens only in response to the pressure of the oil at the fluid inlet orifices 38 exceeding the pressure of the oil in the unfiletered space 30 by a threshold and automatically closes when that pressure difference falls below the threshold. The anti-drainback valve 40 is preferably made of silicon but any suitable resilient material may be employed.

During normal operation of the engine, oil is conveyed by an oil pump (not shown) to the fluid inlet orifices 38, past the anti-drainback valve 40 and into the unfiltered space 32. The oil then passes through the filter media 28, and into the filtered space 30. The filtered oil then travels through the fluid outlet orifice 36 so that it can be guided back to a crankcase in the engine. In certain conditions, such as when the filter media 28 becomes clogged or when the viscosity of the oil exceeds a viscosity threshold of the filter media 28, insufficient oil is able to flow through the filter media 28. In those conditions, a bypass valve assembly 42 opens to allow some oil to flow directly from the unfiltered space 32 to the filtered space 30, thereby ensuring a continuous flow of oil out of the oil filter assembly 20 and to the engine. As discussed in further detail below, the opening and closing of the bypass valve assembly 42 occurs automatically without any electronic sensors or other costly components.

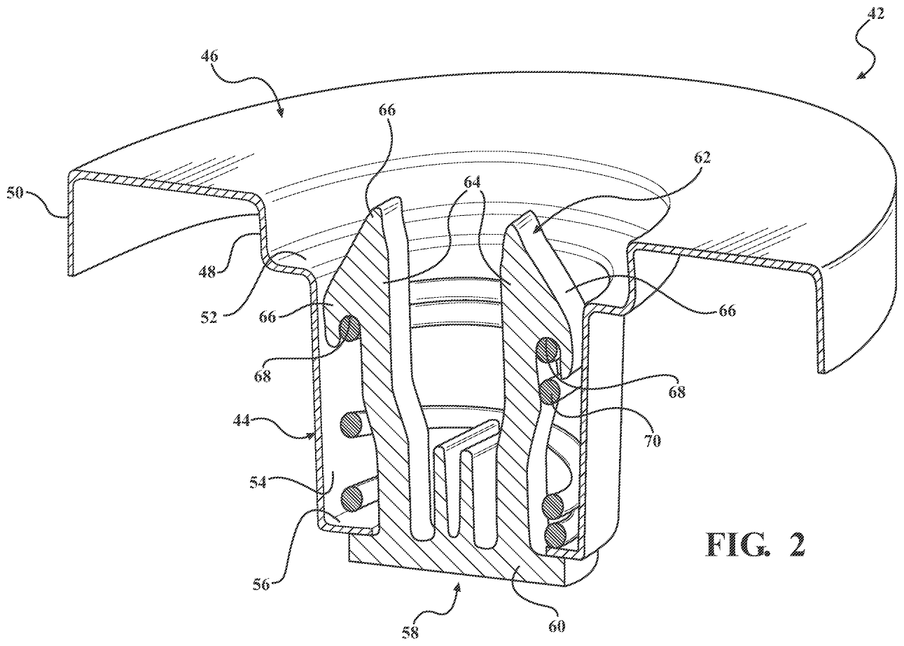

In the exemplary embodiment, the bypass valve assembly 42 is positioned on an opposite side of the filter media 28 from the tapping plate 24. As shown in FIG. 2, the bypass valve assembly 42 includes a single-piece body which includes both a valve housing 44 and an end cap 46. That is, the valve housing 44 and end cap 46 are integrally connected with one another as a single monolithic piece of material. The single piece of material is preferably a metal, such as steel, an alloy steel, aluminum, an aluminum alloy, etc.

The end cap 46 is annular in shape and is positioned on one end face of the filter media 28 to force the oil in the unfiltered space 30 to only flow through the filter media 28 in a radial direction, thereby ensuring proper filtering of the oil. The end cap 46 includes inner and outer shoulders 48, 50 which are spaced from one another in the radial direction. The inner shoulder 48 may be in contact with the center tube 34, and the outer shoulder 50 may be in contact with the outer peaks of the filter media 28. The end cap 46 is preferably bonded with the end face of the filtered media 28 with an adhesive.

The valve housing 44 has a top wall 52, a cylindrical wall 54, and a bottom wall 56. The top wall 52 extends radially inwardly (i.e., in a plane which lies perpendicular to the central axis A) from a lower end of the inner shoulder 46 to the cylindrical wall 54. The cylindrical wall 54 extends in an axial direction towards the tapping plate 24. The bottom wall 56 extends radially inwardly from a lower end of the cylindrical wall 54 to a through opening.

The bypass valve assembly 42 further includes a valve plug 58 which extends through the through opening and can be sealed against the bottom wall 56. The valve plug 58 includes a head portion 60 and a tail portion 62. The head portion 60 is generally circular in shape and has an outer diameter that is greater than a diameter than the through opening in the bottom wall 56. The tail portion 62 includes at least two diametrically opposed fingers 64, each of which extends from the head portion 60 to an end region 66. Each of the fingers 64 is generally shaped like a check-mark and presents a downwardly facing notch 68.

The downwardly facing notches 68 of the fingers 64 and the bottom wall 56 of the valve housing 44 define spring seats for a compression spring 70 which acts on the valve plug 58 to bias the valve plug 58 into a closed position such that the head portion 60 covers the through opening in the bottom wall 56. Thus, when the valve plug 58 is in the closed position, oil is restricted from passing directly from the unfiltered space 32 to the filtered space 30 without passing through the filter media 28. The compression spring 70 is preferably a coil spring and is preferably made of a spring steel material.

As shown in FIG. 2, when the valve plug 58 is in the closed position, the end regions 66 of the fingers 64 project above the top wall 52 of the valve housing 44 but are still entirely recessed below an upper face of the end cap 46, and the radially outer-most portions of the fingers 64 remain below the top wall 52 of the valve housing 44. Thus, in a pre-assembly condition, the end cap 46 can be laid flat on a surface. Also, making the valve plug 58 of a non-metallic material allows for an improved seal between the valve plug 58 and the valve housing 44 as compared to metal-to-metal seals.

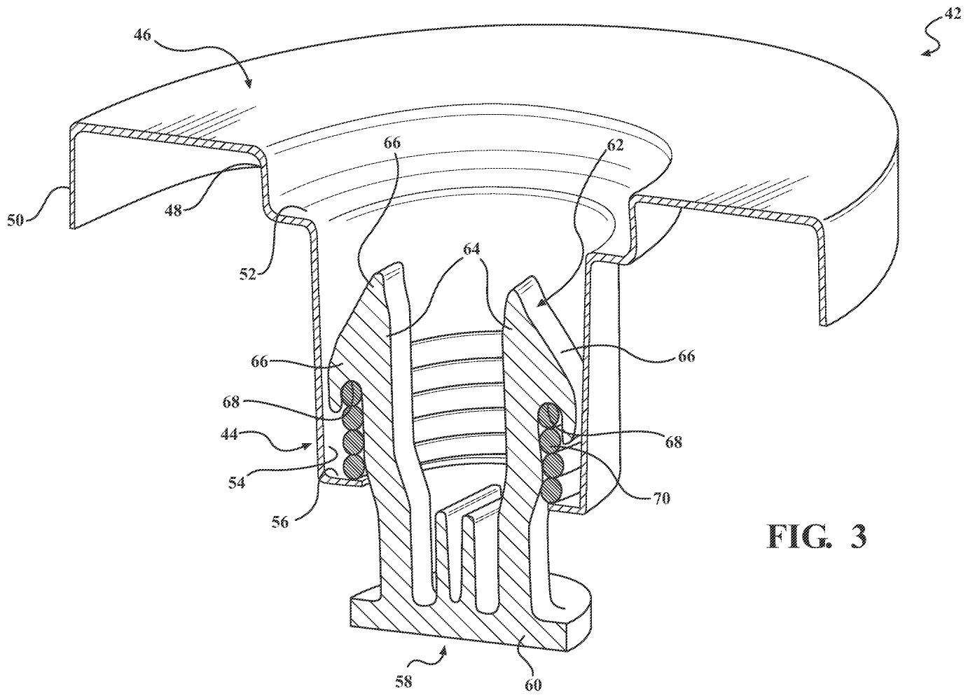

During operation of the engine, if the pressure of the oil in the unfiltered space 32 of the canister 22 exceeds the pressure of the oil in the filtered space 30 by a predetermined amount (which is determined by the stiffness of the compression spring 70 and the size of the through passage of the valve housing 44), then the valve plug 58 will be urged against the force of the compression spring 70 from the closed position to an open position (shown in FIG. 3). That is, when a pressure force from the difference in pressure between the filtered and unfiltered spaces 30, 32 exceeds a spring force from the compression spring 70, the compression spring 70 compresses, and the valve plug 58 is urged into the open position. With the valve plug 58 in the open position, oil is able to flow directly from the unfiltered space 32 to the filtered space 30 while bypassing the filter media 28. Thus, the flow of oil out of the filter assembly 20 and to the engine is not restricted, even if the filter media 28 becomes clogged or the viscosity of the oil is higher than the filter media 28 is capable of filtering.

The radially outer-most portions of the fingers 64 are in a clearance fit relationship with the cylindrical wall 54 of the valve housing 44 such that the cylindrical wall 54 guides the valve plug 58 as it automatically moves between the open and closed positions.

The valve plug 58 is preferably made of a non-metallic material, such as plastic, such that there is no metal to metal scraping contact within the bypass valve assembly 42.

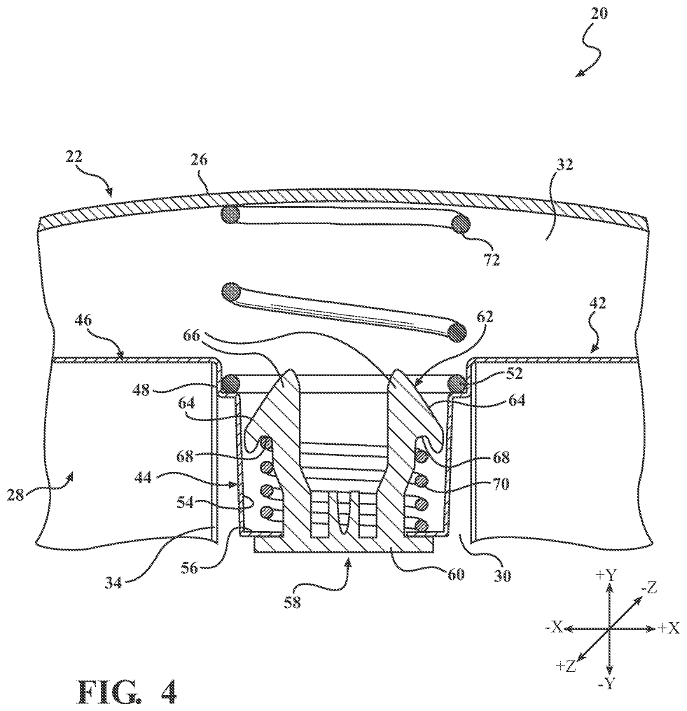

Referring now to FIG. 4, the top wall 52 of the valve housing 44 also functions as a spring seat for a retainer spring 72 which extends from the top wall 52 to an inner surface of the closed end 26 of the canister 22. The retainer spring 72 helps maintain the bypass valve assembly 42 in a central location within the canister 22 and holds the entire cartridge against the anti-drainback valve 40. In the exemplary embodiment of the oil filter assembly 20, the retainer spring is a coil spring.

Another aspect of the present invention is related to a method of making fluid filter assembly 20, such as the oil filter assembly 20 shown in FIG. 1. The method includes the step of preparing the filter media 28. The method proceeds with the step of inserting the tail portion 62 of the valve plug 58 into the through opening of the valve housing 44 and engaging the tail portion 62 with the compression spring 70 to bias the valve plug 58 into the closed position. The method continues with the step of fixedly attaching the end cap 46 and valve housing 44 with an axial end of the filter media 28. The method proceeds with the step of inserting a retainer spring 72 into the valve housing 42. The method continues with the step of inserting the filter media 28 into the container 22.

In the exemplary embodiment, the step of inserting the tail portion 62 into the through opening includes flexing the fingers 64 inwardly (i.e., towards one another and towards the central axis A).

Obviously, many modifications and variations of the present invention are possible in light of the above teachings and may be practiced otherwise than as specifically described while within the scope of the appended claims. Additionally, it is to be understood that all features of all claims and all embodiments can be combined with each other as long as they do not contradict each other. It is to further be understood that directional terms, such as “upper”, “top”, and “bottom” are in reference to the orientations of the various features of the oil filter assembly in the drawings and are not intended to require any particular orientation.

What is claimed is:

1. A fluid filter assembly for filtering a fluid, comprising:
a container which surrounds an enclosed volume;
a filter media disposed in said container and partially dividing said enclosed volume into an unfiltered space and a filtered space;
said filter media encircling and extending along a central axis;
a bypass valve assembly disposed at one axial end of said filter media and including an end cap which is in engagement with an end face of said filter media to force the fluid to flow through said filter media in a radial direction;
said bypass valve assembly further including a valve housing with a through opening;
said bypass valve assembly further including a valve plug with a head portion and a tail portion and being biased into a closed position by a compression spring and being moveable against a spring force from said compression spring from said closed position to an open position to allow the fluid to flow directly from said unfiltered space to said filtered space;
said head portion being disposed in said filtered space and said tail portion extending through said through opening into said unfiltered space; and
said valve housing and said end cap being made as a monolithic piece.

2. The fluid filter assembly as set forth in claim 1 wherein said valve housing presents a cylindrical wall and wherein said tail portion of said valve plug is disposed in an area of said cylindrical wall in both said closed position and said open position.

3. The fluid filter assembly as set forth in claim 1 wherein said tail portion of said valve plug is in a clearance fit relationship with said cylindrical wall of said valve housing.

4. The fluid filter assembly as set forth in claim 3 wherein said tail portion includes at least two fingers and wherein each of said fingers presents a notch for receiving one end of said compression spring.

5. The fluid filter assembly as set forth in claim 4 wherein said valve housing defines a spring seat which supports an opposite end of said compression spring from said fingers.

6. The fluid filter assembly as set forth in claim 4 wherein said fingers have radially outer-most portions which remain within an area surrounded by said cylindrical wall as said valve plug moves from said open position to said closed position.

7. The fluid filter assembly as set forth in claim 1 wherein said valve housing has a top wall which extends radially inwardly from said end cap.

8. The fluid filter assembly as set forth in claim 7 further including a retainer spring which extends from said top wall of said valve housing to an inner surface of said container.

9. A method of making an oil filter assembly, comprising the steps of:
preparing a filter media which encircles a central axis;
inserting a tail portion of a valve plug into a through opening in a valve housing and engaging the tail portion with the compression spring to bias the valve plug into a closed position wherein a head portion of the valve plug covers the through opening;
fixedly attaching an end cap and the valve housing, which are constructed as a single monolithic piece, with an axial end of the filter media;
inserting a compression spring into the valve housing; and
inserting the filter media into an enclosed space of a container.

10. The method as set forth in claim 9 wherein the valve housing has a cylindrical wall and wherein the tail portion of the valve plug is in a clearance fit relationship with the cylindrical wall such that the cylindrical wall guides movement of the valve plug between the closed position and an open position.

11. The method as set forth in claim 10 wherein the tail portion of the valve plug includes at least two fingers and wherein the step of inserting the tail portion into the through opening includes flexing the fingers.

12. The method as set forth in claim 9 wherein the end cap and valve housing are made of metal and wherein the valve plug is made of plastic.

13. The method as set forth in claim 9 wherein the valve housing has a top wall.

14. The method as set forth in claim 13 further including the step of inserting a retainer spring into the unfiltered space and such that the retainer spring contacts the top wall of the valve housing and an inner surface of the container.
